(19) United States
(12) Patent Application Publication
(10) Pub. No.: US 2008/0231929 A1
(43) Pub. Date: Sep. 25, 2008

(54) Frequency-Addressing Matrix Routing Head For Light Beams

(76) Inventor: Jean-Marc Joseph Desaulniers, Cotes d'Armor (FR)

Correspondence Address: Jean-Marc(Joseph) Desaulniers, 9 ter, rue de l'lc, Binic, 22520, FR

(21) Appl. No.: 11/914,749

(22) PCT Filed: May 11, 2006
(86) PCT No.: PCT/FR2006/001057

§ 371 Date: Nov. 17, 2007

(30) Foreign Application Priority Data
May 24, 2005 (FR) 0505178

(51) Int. Cl. G02B 26/08

(52) U.S. Cl. 359/204

(57) ABSTRACT

The invention is about a device (FIG. 1) with a radial structure generating a collimated colinear, or brought colinear, group of beams, with a matricial shape (22) in order to feed, i.e. the last stage of a digital video projector.

The collimated colinear group of beams is built from a combination of spectral sources and a certain number of mirrors or filters of a certain size and shape, defined according to the targeted application, enabling appropriate frequential filtering linked to the configuration of mirrors or filters. At its center the device include, a certain number of mirrors or filters aligned geometrically, orienting and filtering the different beams in order to build a specific multi-beam matricial element or symbol. The device addresses simultaneously the whole group of beams from the output matrix with a specific frequential coding according to the position of each constitutive element of the matrix (22) or symbol created. The digital control function triggers the lightning of each source according to the specific matrix (22) or symbol to obtain at a specific instant or “t” time, i.e. that could be scanned on a surface in order to generate a complex video sequence. The device will be applied i.e. to high end Digital Cinema of 2nd Generation, Home Cinema and to telecommunications.

### FIELD OF THE INVENTION

The current invention concerns a device enabling use, through a light beam matrix, of the last stage of a video projector for Digital Cinema of 2nd Generation, in order to project on a wide screen an Ultra High Definition RGB video signal, using a laser of low/medium power or a white light generated i.e. by xenon lamp of very high intensity as a light source. Spatial and frequential flexibility of such optical device enables application in telecommunication fields (i.e. router, wavelength multiplexer/demultiplexer, optical switch, optical coupler, polarization analyzer, . . .).

### BACKGROUND OF THE INVENTION

The projection in theaters is traditionally performed by means of a film projector 35 mm or 70 mm. A certain number of implementations based on DLP or LCD technology supporting a 2K×1K pixels resolution and a prototype, based on GLV technology supporting 2K×4K pixels resolution, are now available. Use of such technologies applied to higher resolution induces exponential costs linked to the development of basic elements (DLP, LCD or GLV components). Using microscopic metallic components (DMD Micro-mirrors for DLP technology and thin micro-blades for GLV technology), induces residual magnetic field problems, resonance, early aging (resulting from multiple repetitive torsions), oxidation and limitation in terms of maximal sweeping/refreshing frequency to be reached. At LCD level, the main problems are inherent to the use of: 1) dichroïc filters inducing loss of transmission and distorsion of basic color/RGB components (RGB ratio, gamut and color temperature), at the level of the recombined signal. 2) LCD shutter matrix with a maximal activation/deactivation frequency (shuttering cycle). These conjugated effects do not ease the optimization process of color mix/temperature/gamut with sufficient contrast level, required by theater users. The application range is high quality Digital Cinema oriented in the first place, then will be re-applied to other market segments (i.e. “Home Cinema”), once the integration level (size reduction of the scanning mechanism) and the industrialization cost have both been sufficiently optimized.

### SUMMARY OF THE INVENTION

The device under patent enables reproduction of an Ultra High Definition (UHD) image sequence, from a light source, onto a screen of variable size and shape, thanks to a frequency-addressing routing head for light beams. The goal is to preserve the intrinsic characteristics of the original signal (gamut, spectrum, resolution, contrast level, . . . ). The video projection performed by an almost entirely optical device (light beam+microscopic mirrors/filters) is thus optimized, since it does involve only a series of reflections/transmissions on mirrors/filters, which at the end will experience very limited mechanical wearing.

This device allows to create a matricial light beam (1), using a scheme of low/medium power light sources, i.e. (2), (3) and (4), which supports the three basic colors (Red, Green, Blue), from laser sources of a filtered white light, and a scheme of “n”×“m” mirrors (5), realizing a specific filtering, with a size and shape defined resulting from the mirror/filter construction. The device comprises a certain number of matrixes of geometrically aligned mirrors/filters, i.e. (6), (7), (8) and (9), which adjust and filter light beams (10) in order to generate a matricial element or a symbol of projection (1). The system frees itself from a scanning function using a frequential coding of each matricial element. Light source switches on control is performed by a digital command which is related to the layout of the configuration display matrix or symbol at a specific “t” time. This matricial element or symbol will be scanned onto a projection surface in order to generate a complex video sequence.

The operating principle includes a light beam matricial scanning over a specific area, as part of a video screen, by insertion of a frequency-comb related to a specific part of spectrum reflected several times by matricial arrangement of microscopic mirrors. The beam will have a diameter in a range of 0.03 mm up to 10 mm, in compliance with targeted application, at the last stage of the projection sub-system. Instead of using a common temporal and spatial screen scanning, a frequential scanning method is used through mirror/filters covered with a thin metallic layer, which allows light beam reflections and/or transmissions onto a matricial display surface. Each comb composed of different frequencies, which depend on the targeted matrix structure (n×m), performs a matricial symbol code in the last stage of the projection system. The comb pulse frequency represents the simultaneous regenerating time interval of all the matrix elements. Intensity modulation of each frequency corresponds to each pixel regeneration time interval.

In the first stage of the device, the frequency comb passes through a succession of microscopic mirrors which, according to their specifications, transmit part of the spectrum and reflect what remains. The microscopic mirrors succession enables a matricial geometric dispatch of the incident beam.

According to specific configuration modes:

The device (FIG. 1) is lighted up by a continuous or discrete light spectrum. The microscopic mirrors/filters could present the same specification or not, depending on targeted application.

A group of mirrors/filters having identical frequential specifications but a variable reflection/transmission rate by step enables to create a <<n>>×<<m>> light beam matrix issued from a punctual source.

### BRIEF DESCRIPTION OF THE DRAWINGS

The invention is illustrated by the following Figures:

FIG. 1 is a view of the complete device under patent.

FIG. 2 is a section view of a single mirror/filter.

FIG. 3 is a section view of part of a line or column from a matrix level composed with a succession of single mirror/filter

FIG. 4 illustrates a view of the lower matrix level.

FIG. 5 illustrates a view of one of the upper matrix level.

FIG. 6 illustrates a section view of upper level part from the matrix enabling spectral and spatial cutting and reassembling of each pixel.

FIG. 7 illustrates a section view of a variant configuration of the device characterized by a light source set spread around an axis, composed by one or more superposed and incrementing size crowns mounted with some mirrors/filters.

FIG. 8 illustrates a front view of a variant configuration of the device characterized by a light source set spread around an axis, composed of several mirrors/filters crowns.

FIG. 9 illustrates a front view of the crown described in the previous figure, mounted with mirrors/filters.

FIG. 10 illustrates a front view of the variant mirrors/filters matrix, arranged in a pyramid-shaped in three incremental surface stages mounted, i.e. with 4, 12 and 20 mirrors/filters.

FIG. 11 illustrates one of the mirrors/filters from the inclined device with i.e. a 45 degree tilt.

### DETAILED DESCRIPTION OF PREFERRED EMBODIMENTS

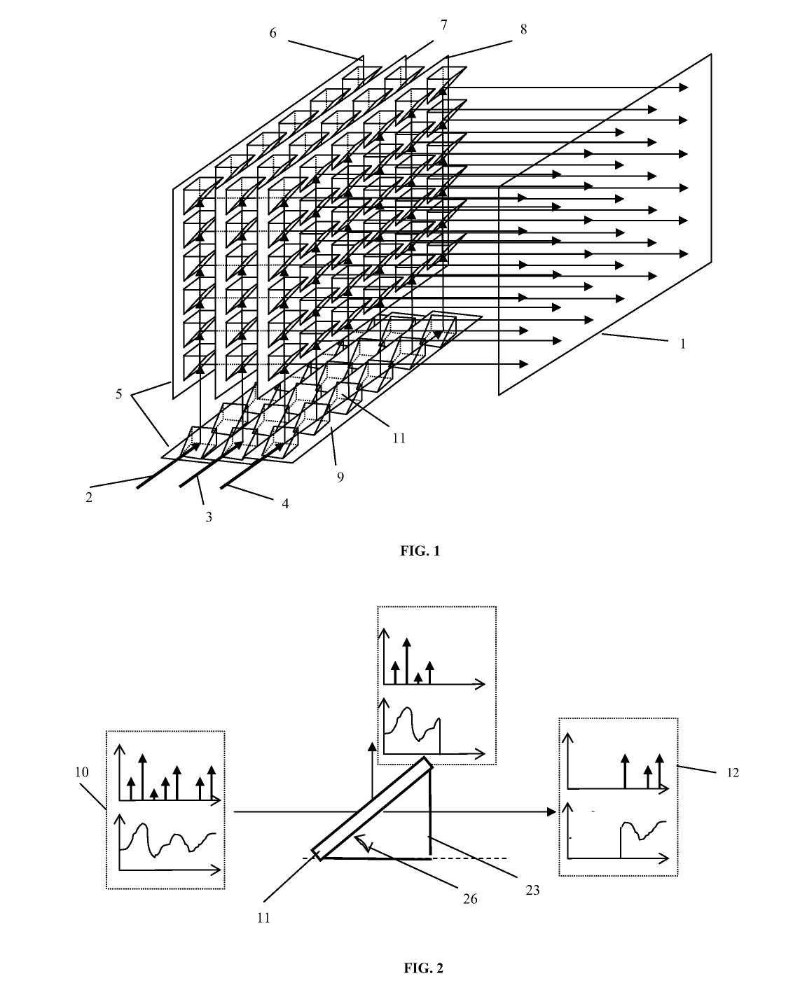

As a reference to the drawings, on FIG. 1 the device involves an upper and lower stage succession composed of a certain number of mirrors/filters defined according to the foreseen application.

A prism or a thin strip covered with a metallic layer is used to create the elementary component: mirror/filter (FIG. 2) According to the foreseen application, this processing enables transmission or reflection of a part of the incoming beam specifications (i.e. intensity, spectrum, polarization, etc). According to the technical process, the elementary component mirror/filter is integrated in the device or laid down over the surface.

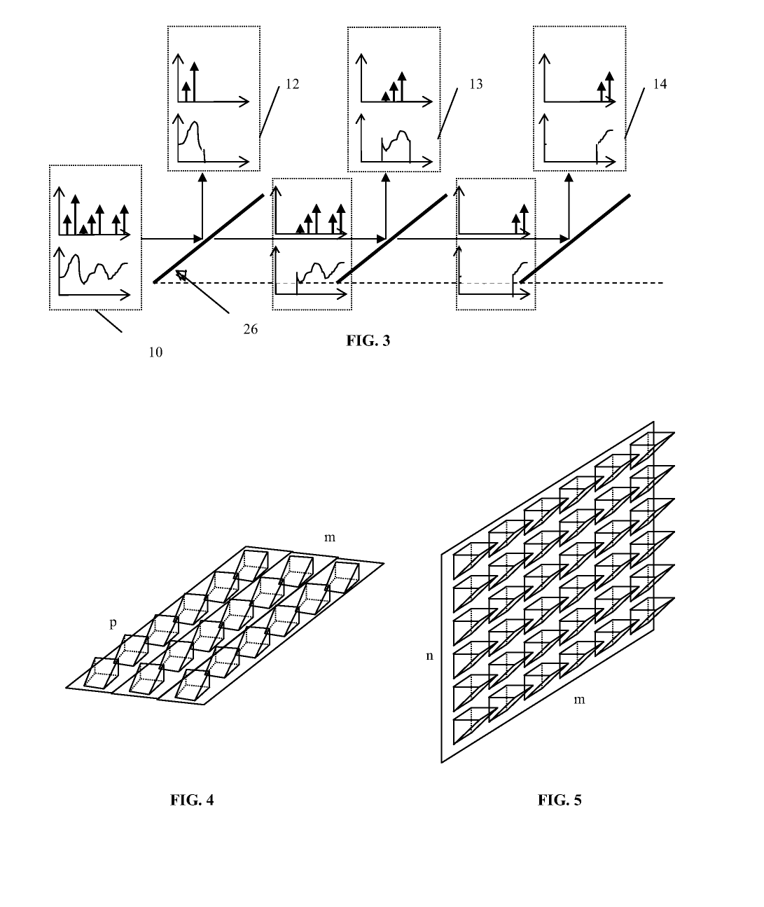

A <<m>> mirrors/filters linking (FIG. 3) through a wavelength selective mirror succession, enables a spatial partition of the incoming beam (10) into <<m>> different beam with specific different components (12), (13) and (14). Each spectral component is determined by mirror/filter characteristics during their construction.

The lower stage (FIG. 4) consists of <<m>> elementary mirrors/filters succession along <<p>> lines (i.e. three lines for the three basic colors RGB). Each of the lined up surface enables spatial addressing of each <<m>> column composed by <<n>> lined up surfaces on a matrix upper stage (FIG. 5). In this context, the lower matrix addresses a column of the device output beam matrix.

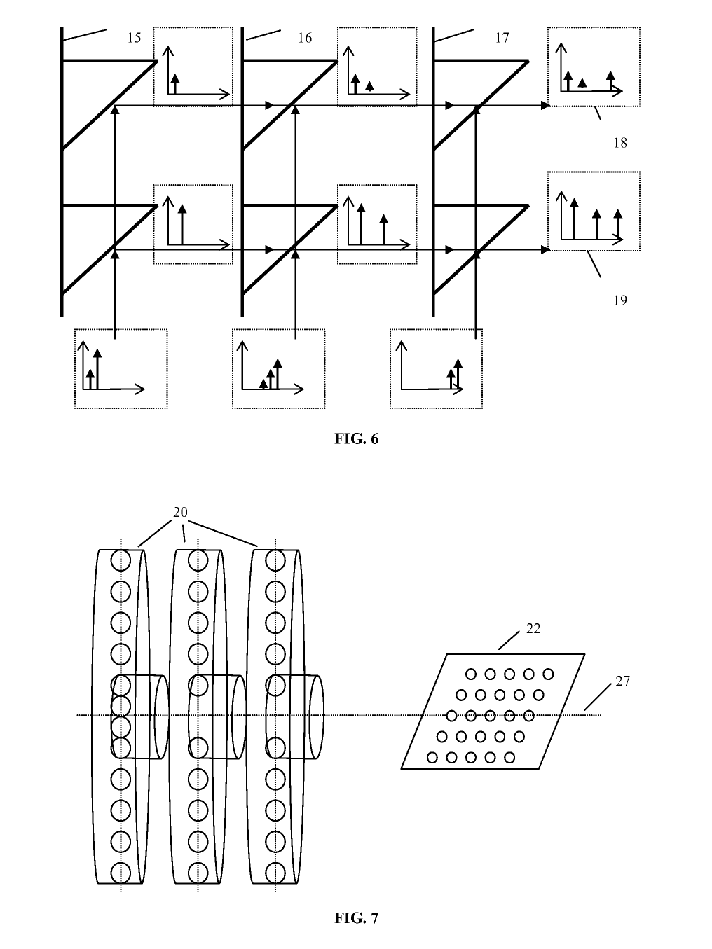

Upper stages perform, as shown in FIG. 6, a beam position selection on the column through a mirror/filter succession (15), (16), and (17) using wavelength selective mirrors/filters. The <<p>> upper stages superposition enables spectral recombination of each beam (18) and (19), i.e. each RGB component of each output matrix pixel, defining the output matrix of the device.

According to the configuration and foreseen application, and possibility of reverse mode, this device may not only be used to obtain a singular beam matrix with one or more incident beam (i.e. simultaneous generation of a RGB pixel matrix representing a picture through frequential coding of the information), but also as a single or multi-beam generator based on an incoming beam matrix (i.e. the frequential generation of a picture).

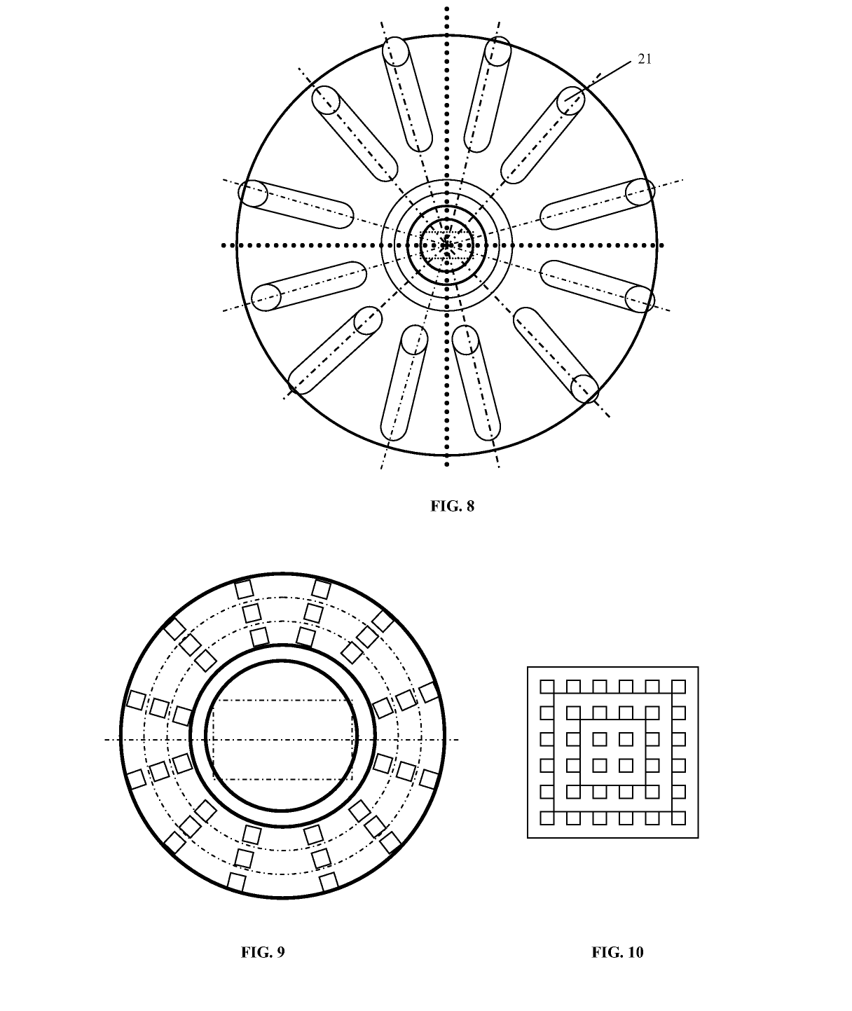

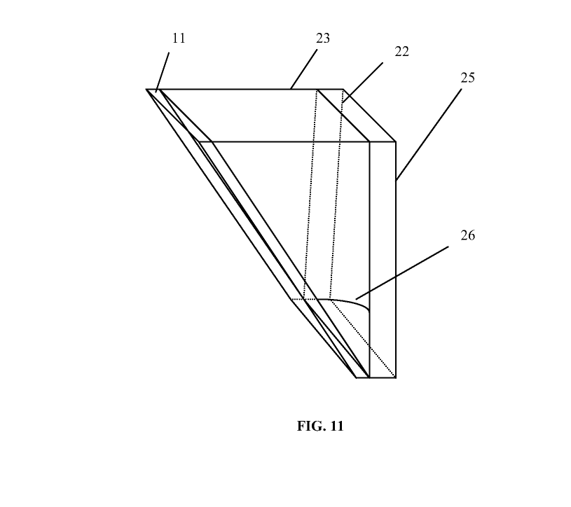

The device shown in FIG. 7 presents another disposition of the device that performs a matricial laser beam generator supplying the last stage of a digital video projector, using a combination low/medium power laser sources scheme that carries basic colors (Red Green and Blue), and a prismatic mirror. The device comprises a certain number of rings (20) where each laser heads are oriented toward the center of each ring (FIG. 8) where mirrors/filters (FIG. 11) line up each laser beam in order to create a projection matricial element/symbol (22). Mirrors/filters are laid down over a certain number of static or rotating crowns (FIG. 9) in order to generate the required light beam matrix. A digital command allows laser heads ignition according to the requested matrix/symbol configuration at a specific “t” time. The application range of this system will be targeting high end Digital Cinema in first place, then other market such as “Home Cinema”.

I claim:

1) An Optical Matricial Head device characterized by a collimated colinear or brought colinear matricial group of beams according to a free pattern, with matricial or concentric shape, from a certain number of sources dispatched radially and addressing an optical frequency comb on mirrors or filters, organized spatially, according to a geometrical alignment, so as to perform, through a succession of reflections or transmissions, a multi-beam scanning of a zone for video projection or telecommunication applications.

2) An Optical Matricial Head device according to claim 1 characterized by: a radial structure, a combination of rings integrating a certain number of sources oriented toward the center of each ring, a certain number of stages of crowns or pyramids or cones that may be placed under rotation, onto which a certain number of mirrors elements or filters, tilted with an angle enabling a normal reflection according to the output plane, are spreaded.

3) An Optical Matricial Head device according to claims 1 and 2 characterized by a center having a radial structure, a structure of passive elements with an alignment of mirrors or filters, ultra-selective at spectrum frequency level, tilted and spreaded on a certain number of stages, enabling simultaneously scanning, or spatial addressing, of a collimated colinear group of beams, by a series of reflections or transmissions and a frequential and spatial coding of each elementary pixels within the matricial beams, from an input frequency comb where each position on the output matrix corresponds to a specific frequential signature at the input.

4) An Optical Matricial Head device according to claim 1 to 3 characterized by a pulsed, discreet or continuous frequency comb, generated by light sources addressing device, where each constituent frequency, determined by the foreseen application, enabling symbol coding, where each point on the output matrix corresponds to a specific part of spectrum, under an amplitude modulation, inside a beam associated to one of the pixels from the dot matrix, with a period enabling video sequence projection or multi-beam data transport.

5) An Optical Matricial Head device according to claim 1 to 4 characterized by a single-spectral signature of each beam on the output matrix, coming from spectral decomposition and recombination performed by upper and lower stages, generating a matricial distribution of specific passive optical elements, enabling reflection, transmission or ultra-selective filtering of the incoming beam according to one or more of its physical specifications as wavelength cutoff decreasing step about nanometer, thus creating different component of Red Green and Blue on each location in the output matrix.

6) An Optical Matricial Head device according to claim 1 to 5 characterized by a reverse usage mode, as a bidirectionnal device, which enables spatial information coding on a frequency comb, which performs in a passive way and from an input beam matrix an output signal or beam with individual amplitude and temporal modulation of wavelengths according to the input matrix physical location of each beam, performing i.e. a frequency division multiplexing function by recombination, as a frequency comb, of the different incoming beams basic frequency that are spatially spread, performing simultaneously a multi-beam data transport function.

7) An Optical Matricial Head device according to claims 1 to 6 characterized by an elementary building block of mirrors or filters, within or at the surface, enabling according to the foreseen application, to realize a structure where each elementary building block successively crossed enables the creation of a collimated colinear multi-beam symbol at the output function of: spatial addressing orientation, tilt, reflection, or of an ultraselective and progressive frequency spectrum filtering at the input, such device enabling the frequency comb processing in order to perform a specific spatial and frequency addressing.
